(19) United States
(12) Patent Application Publication
(10) Pub. No.: US 2008/0301306 A1
(43) Pub. Date: Dec. 4, 2008

(54) FAST SESSION ESTABLISHMENT METHOD AND SYSTEM FOR MOBILE TERMINAL

(76) Inventors: Dae Won An, Gumi-si (KR); Cedric Ding Hin Lam, Gumi-si (KR)

Correspondence Address: CHA & REITER, LLC, 210 ROUTE 4 EAST STE 103, PARAMUS, NJ, 07652, US

(21) Appl. No.: 11/970,567

(22) Filed: Jan. 8, 2008

(30) Foreign Application Priority Data
Jun. 1, 2007 (KR) 2007-0054093

(51) Int. Cl. G06F 15/16; H04M 1/00

(52) U.S. Cl. 709/228; 455/550.1

(57) ABSTRACT

A fast session establishment method and system is provided for reducing time required to establish a multimedia communication session. The fast session establishment method includes registering a parameter set that had resulted in a successful session establishment with a counterpart terminal and establishing a session with the counterpart terminal using the parameter set resulting in a prior successful session.

### CLAIM OF PRIORITY

This application claims the benefit of the earlier filing date, pursuant to 35 USC §119, to that patent application entitled “FAST SESSION ESTABLISHMENT METHOD AND SYSTEM FOR MOBILE TERMINAL,” filed in the Korean Intellectual Property Office on Jun. 1, 2007 and assigned Serial No. 2007-0054093, the contents of which are incorporated herein by reference.

### BACKGROUND OF THE INVENTION

1. Field of the Invention

The present invention relates to a multimedia communication and, in particular, to a fast session establishment method and system for reducing time required to establish a multimedia communication session.

2. Description of the Related Art

H.324M is an extension of the International Telecommunication Union (ITU) protocol standard for multimedia communication over general switched networks H.324, for operations over mobile networks and adopted for 3^{rd} generation (3G) mobile communication systems.

Typically, H.324M data is exchanged over a circuit switched data (CSD) message. In order to establish a multimedia session, H.245 messages are exchanged between H.324M terminals. The H.245 messages include Terminal Capability Set (TCS), Master-Slave Determination (MSD), and Open Logical Channel (OLC) messages. The TCS messages are used for exchanging the terminal capabilities, and the MSD message are used for determining a master-slave relationship of the terminals. The OLC messages are exchanged for opening a logical channel between the terminals. The OLC message carries information on a media capability of the channel such as codec information and channel parameters such as protocol address and port numbers. Typically, audio and video are transmitted through different logical channels. H.324M logical channels can be unidirectional or bidirectional. Accordingly, four (4) unidirectional logical channels (2 for video and audio in forward direction and 2 for video and audio in a reverse direction) or 2 bidirectional logical channels (1 for video and 1 for audio) are used.

After a multimedia session is established and the logical channels are open, the master and slave channel can exchange the audio and video data through the logical channels.

During the OLC message exchange, the master terminal transmits an OLC request message containing a set of parameters defining the session to the slave terminal. The parameters include the logical channel number, media capability indicating codecs to be used, and multiplexer parameters. The slave terminal determines whether its capability and parameters meet or satisfies the capability and parameters defined in the OLC request message and transmits an acknowledgement message or a reject message in response to the OLC request message. When the slave terminal does not support the capability and parameters defined in the OLC request message, it is called an OLC parameter collision. If the OLC parameter collision occurs, the slave terminal transmits the OLC reject message to the master terminal.

Upon receiving the OLC reject message, the master terminal transmits the OLC request message containing a set of different parameters. The OLC request message transmission is repeated until the acknowledgement message is received from the slave terminal. The repeated OLC message exchange causes round trip delay of the establishment of the logical channels, resulting in multimedia session establishment delay.

Typically, the parameter set is selected in a regular stepwise order such that the parameter collision between two terminals having significant capability difference occurs repeatedly whenever trying to establish a multimedia session. That is, the logical channel establishment delay occurs with the same counterpart terminal repeatedly. Accordingly, a user may have an uncomfortably long wait whenever making a multimedia call to a specific recipient's terminal, particularly, when the recipient is one of most frequently communicating persons.

### SUMMARY OF THE INVENTION

The present invention provides a fast session establishment method and system for multimedia communication.

The present invention also provides a fast session establishment method and system that are capable of reducing the time required to establish a multimedia call by avoiding unnecessary OLC parameter collisions with a known terminal.

In accordance with an aspect of the present invention, a fast session establishment method includes registering a parameter set resulting from a prior successful session establishment with a counterpart terminal; and establishing a session with the counterpart terminal using the parameter set.

In accordance with another aspect of the present invention, a fast session establishment method includes determining, if a logical channel setup is required for a counterpart terminal, whether a parameter set matching the counterpart terminal exists, requesting, if a parameter set matched the counterpart terminal exists, a logical channel setup using the parameter set and requesting, if a parameter set matching the counterpart terminal does not exist, a logical channel setup using a parameter set selected in a predetermined preference order.

In accordance with another aspect of the present invention, a mobile terminal includes a radio frequency unit for processing incoming and outgoing radio signals, a storage unit for storing a session management database and a control unit for controlling establishment of a logical channel with a counterpart terminal using a parameter set matched with an identification of a counterpart terminal, retrieved from the session management database.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a mobile terminal according to an exemplary embodiment of the present invention;

FIG. 2 is a diagram illustrating message exchanges for a session establishment between two mobile terminals according to an exemplary embodiment of the present invention;

FIG. 3 is a diagram illustrating message exchanges for a session establishment between two mobile terminals according to another exemplary embodiment of the present invention; and

FIG. 4 is a flowchart illustrating a fast session establishment method according to an exemplary embodiment of the present invention.

### DETAILED DESCRIPTION OF THE INVENTION

Embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

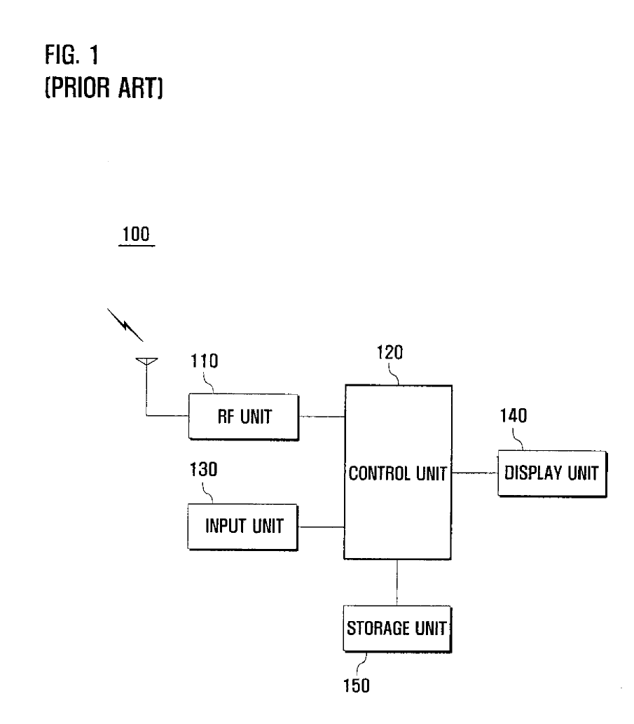

FIG. 1 is a block diagram illustrating a configuration of a mobile terminal according to an exemplary embodiment of the present invention.

Referring to FIG. 1, the mobile terminal 100 includes a radio frequency (RF) unit 110 responsible for radio communication, a storage unit 150 for storing parameters associated with sessions in the form of a database, an input unit 130 for receiving key sequence input by user, a display unit 140 for displaying visual information, and a control unit 120 for controlling to set up logical channels with a set of parameters indicated by a counterpart terminal identifier (ID) with reference to the database.

The RF unit 110 includes a pair of RF transmitter and RF receiver. The RF unit 110 may be provided with a short range wireless communication module such as Infrared Data Association (IrDA) module or Bluetooth module.

The storage unit 120 is provided with a nonvolatile memory and a volatile memory and an optional removable storage media.

The control unit 120 can be a Mobile Station Modem (MSM) which is provided with an internal memory and a codec for coding and decoding multimedia signals.

The control unit 120 controls such that the mobile terminal 100 exchanges the TCS and MSD messages with a counterpart terminal.

The control unit 120 generates an OLC request message containing a codec type and a parameter set that is transmitted to the counterpart terminal. A parameter set is matched with terminal IDs of the terminals with which the logical channels are successfully established using the parameter set. The parameter set is stored in association with the terminal IDs.

The input unit 130 may be provided with at least one of a keypad and a touchscreen implemented on the display unit 140.

The mobile terminal 100 can also be provided with at least one of a memory slot for receiving a external storage media, such as memory card, a camera module, a broadcast receiver, an audio output device, such as speaker, an audio input device, such as microphone, a data connection port for connecting to an external device, a charger port for charging the mobile terminal, and audio playback module, such as MP3 module.

Although all kinds of devices suitable for operation herein, are not listed, it is obvious to those skilled in the art that the mobile terminal can integrate various kinds of devices for implementing other supplementary functions.

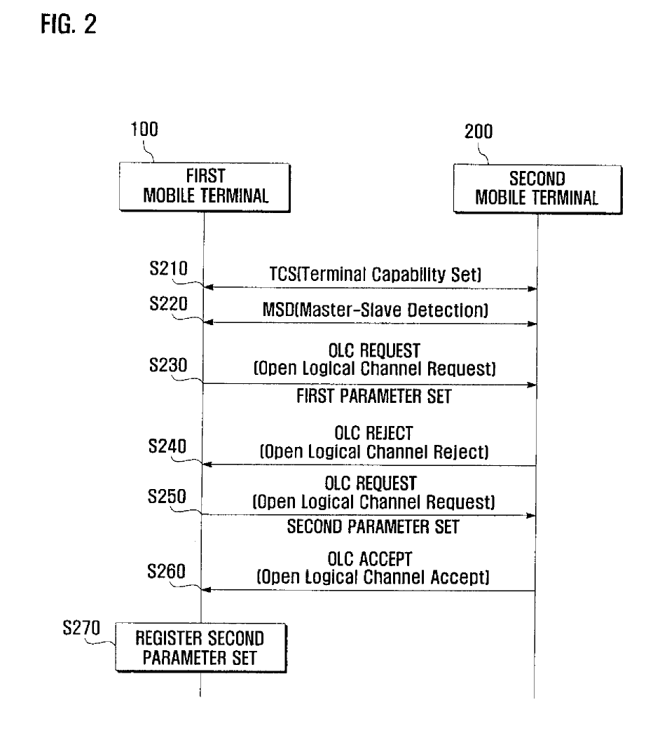

FIG. 2 is a diagram illustrating message exchanges for a session establishment between two mobile terminals according to an exemplary embodiment of the present invention. In FIG. 2, a first mobile terminal 100 and a second mobile terminal 200 are exchanging messages for establishing a multimedia session.

Referring to FIG. 2, if a call is made from one of the mobile terminals 100 and 200, the first and second mobile terminals 100 and 200 exchange TCS messages (S210). Alter exchanging the TCS messages, the first and second mobile terminals 100 and 200 exchange MSD messages (S220). Once the master and slave terminals are determined, the first mobile terminal transmits an OLC request message to the second mobile terminal 200 (S230). The OLC request message includes a first parameter set containing information on the capability required. The capability may include codec type indicating a video codec (for example, MPEG4 or H.263 codec) and an audio codec (for example, Adaptive Multi Rate—NarrowBand (AMR-NB), or G723.1 codec). The first parameter set may further contain the channel parameters.

When the OLC request message is received, the second mobile terminal 200 determines whether the first parameter set is supportable. In this embodiment, the first parameter set is not supported by the second mobile terminal 200 and hence the second mobile terminal 200 transmits an OLC reject message to the first mobile terminal 100 for rejecting the establishment of the logical channel based on the first parameter set (S240).

When the OLC reject message is received, the first mobile 100 terminal transmits the OLC request message containing a second parameter set to the second mobile terminal 200 (S250). The second parameter set includes parameters different from those of the first parameter set. In this embodiment, it is assumed that the first parameter set includes parameters indicating MPEG4 and AMR-NB codecs and the second parameter set includes parameters indicating H.263 and G.723.1 codecs.

The second mobile terminal 200 determines whether the second parameter set is supportable for establishing a logical channel. In this example, the second parameter set is supported by the second mobile terminal 200, and the second mobile terminal 200 transmits an OLC accept message to the first mobile terminal 100 (S260).

When the OLC accept message is received, the first mobile terminal 100 registers the second parameter set to an OLC acceptance table with an identification (e.g., a phone number) of the second mobile terminal 200 (S270). Table 1 shows an example of the OLC acceptance table.

TABLE 1

| Phone number | Video codec | Audio codec |
|---|---|---|
| 010-xxx-xxxx | H.263 | G.723.1 |
| 011-xxx-xxxx | MPEG4 | AMR-NB |
| . . . | . . . | . . . |

The first mobile terminal 100 is provided with an OLC acceptance table, as shown in table 1, in which the identification (phone number) of the second mobile terminal 200 matched the video and audio codecs with which the logical channel has been successfully set up.

If the logical channel setup is completed, the first and second mobile terminal exchange multiplexer table entries (MTE) messages with each other. Once the exchange oft MTE message has been completed, the first and second mobile terminals 100 and 200 can communicate multimedia data (audio, video, and data) with each other.

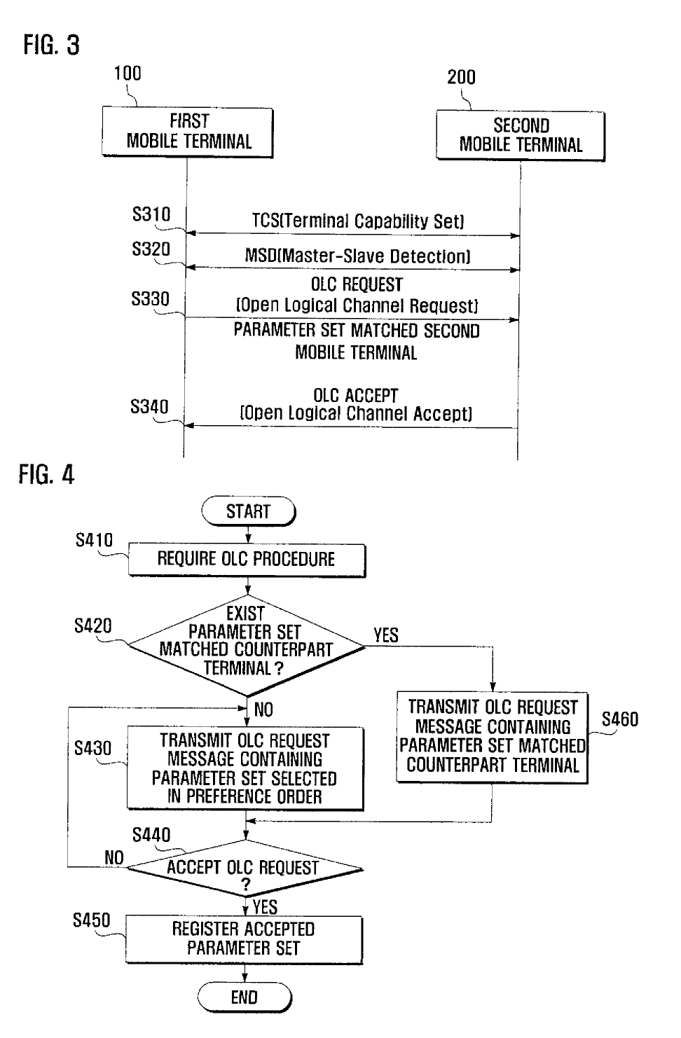

FIG. 3 is a diagram illustrating message exchanges for a session establishment between two mobile terminals according to another exemplary embodiment of the present invention. In this embodiment, the first mobile terminal 100 has communicated with the second mobile terminal 200 at least one time such that the second mobile terminal 200 is registered to the OLC acceptance table of the first mobile terminal 100.

Referring to FIG. 3, it a call is made from one of the mobile terminals 100 and 200, the first and second mobile terminals 100 and 200 exchange the TCS messages (S310). After exchanging the TCS messages, the first and second mobile terminals exchange the MSD messages (S320). Once the master and slave terminals are determined, the first mobile terminal transmits the OLC request message to the second mobile terminal 200 (S330). At this time, the first mobile terminal searches for the terminal identification (e.g., phone number) of the second mobile terminal in the OLC acceptance table. If the phone number of the second mobile terminal is retrieved in the OLC acceptance table, the first mobile terminal 100 generates the OLC request message with the parameter set matching the identification (phone number) of the second mobile terminal 200. Since the parameter set had been used for a prior successful setup of the logical channel with the second mobile terminal 200, the logical channel can be set up without OLC parameter collisions.

Accordingly, upon receiving the OLC request message, the second mobile terminal 340 transmits the OLC accept message to the first mobile terminal 100 immediately (S340).

In FIGS. 2 and 3, the session establishment procedures have been described in a restricted situation focused on the features of the present invention. However, the fast session establishment method of the present invention can be generalized.

FIG. 4 is a flowchart illustrating a fast session establishment method according to an exemplary embodiment of the present invention.

Referring to FIG. 4, if an OLC procedure is required (S410), the control unit 120 searches for a phone number of the counterpart terminal in the OLC acceptance table and determines whether a parameter set matching the counterpart terminal (S420) is known.

If a parameter set matched to the counterpart terminal is not available, the control unit 120 transmits an OLC request message contained a parameter set selected in a preferred order to the counter terminal (S430). Next, the control unit 120 waits for an OLC response message and determines, when an OLC response is received, whether the OLC response message is an OLC accept message (S440).

When an OLC response message is not the OLC accept message, i.e. the OLC reject message is received, the control unit 120 again transmits the OLC request message contained a next parameter set selected in a preferred order (S430). The OLC request message transmission is repeated until the OLC accept message is received.

It the OLC accept message is received, the control unit 120 registers the parameter set accepted by the counterpart terminal to the OLC acceptance table together with the identification (phone number) of the counterpart mobile terminal (S450). The OLC acceptance table stores the parameter set with the phone number as a parameter set index.

Returning to step S420, if a parameter set matched to the counterpart terminal is retrieved from the memory, the control unit 120 generates the OLC request message with the retrieved parameter set and transmits the OLC request message to the counterpart terminal (S460). Next, the control unit 120 determines whether the OLC accept message is received from the counterpart terminal (S440) and stores, when the OLC accept message is received, the parameter set with the phone number of the counterpart terminal (S450). On the other hand, if an OLC reject message is received from the counterpart terminal, the control unit 120 transmits the OLC request message containing the parameter set selected in the preferred order until the OLC accept message is received (S430 and S440).

Before step S410, a circuit switching call setup, protocol stack initialization, TCS exchange procedure, and MSD exchange procedure can be performed between the two terminals.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

For example, the fast session establishment method of the present invention can be applied to a session establishment technique for communicating multimedia data after a circuit switched (CS) call setup such as CSI (combining CS and IMS) in which parameter negotiation is required for establishing a session as in the session initiation protocol (SIP) based on the H.323 and IP Multimedia Subsystem (IMS).

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As described above, the fast session establishment method and system of the present invention allow a mobile terminal to maintain a table registering parameter sets matched to the phone numbers of mobile terminals with which OLC setup have been succeeded such that the mobile terminal attempt to OLC setup with the corresponding parameter set, thereby avoiding OLC parameter collision with the known terminals.

What is claimed is:

1. A fast session establishment method operable in a first terminal, said method comprising:
registering a parameter set that had resulted in a successful session establishment with a counterpart terminal in a prior establishment; and
establishing a session with the counterpart terminal using the registered parameter set.

2. The fast session establishment method of claim 1, wherein the parameter set includes parameters indicating codecs required for setting up a logical channel.

3. The fast session establishment method of claim 2, wherein the session is a multimedia session for flow of video call data.

4. A fast session establishment method comprising:
determining, when a logical channel setup is required for a counterpart terminal, whether a parameter set matched to the counterpart terminal exists;
requesting, when a parameter set matched to the counterpart terminal exists, a logical channel setup using the parameter set; and
requesting, when a parameter set matched the counterpart terminal does not exist, a logical channel setup using a parameter set selected in a predetermined preference order.

5. The fast session establishment method of claim 4, further comprising:
determining whether the logical channel setup is accepted;
registering, when the logical channel setup is accepted, the parameter set with an identification of the counterpart terminal; and
requesting, when the logical channel set is rejected, the logical channel set with another parameter set selected in the preference order.

6. The fast session establishment method of claim 5, wherein registering the parameter set comprises matching the parameter set with the identification of the counterpart terminal.

7. The fast session establishment method of claim 6, wherein the parameter set comprises parameters indicating at least one of video and audio codec.

8. The fast session establishment method of claim 6, wherein the session is a multimedia session for flowing video call data over a circuit switched data channel.

9. The fast session establishment method of claim 4, further comprising:
establishing a circuit switched data channel with the counterpart terminal;
initializing a protocol stack required for multimedia data communication;
exchanging terminal capability set messages with the counterpart terminal; and
exchanging master-slave determination messages with the counterpart terminal.

10. A mobile terminal comprising:
a radio frequency unit for processing incoming and outgoing radio signals;
a storage unit for storing a session management database; and
a control unit for controlling establishment of a logical channel with a counterpart terminal using a parameter set matched with an identification of the counterpart terminal, retrieved from the session management database.

11. The mobile terminal of claim 10, wherein the control unit controls registering the parameter set with which a logical channel is successfully set up with the counterpart terminal in a prior setup.

12. The mobile terminal of claim 11, wherein the parameter set is matched with the identification of the counterpart terminal.

13. The mobile terminal of claim 12, wherein the parameter set comprises parameters indicating at least one of video and audio codecs.

14. The mobile terminal of claim 10, wherein the session is a multimedia session for flowing video call data over a circuit switched data channel.

15. The terminal of claim 10, wherein the identification is a phone number.

16. A mobile terminal comprising:
an transmitting/receiving unit for transmitting/receiving a signal in an RF domain;
a processor in communication the transmitting/receiving device and with a memory, the memory including code which when accessed by the processor causes the processor to:
transmit a message to establish communication with a second terminal; said establishment message including a set of known parameters; and
store the transmitted set of known parameters in said memory upon receiving an acknowledgement in response to said establishment message, aid known parameters being associated with an identification of said second terminal.

17. The terminal of claim 16, wherein said identification of said second terminal is a phone number.

18. The terminal of claim 16, wherein said known parameters are selected from the group consisting of: stored parameters associated with a specific second terminal and default parameters.

19. The terminal of claim 16, wherein said processor further executes code for:
altering said known parameters in a predetermined manner upon receipt of a negative acknowledgement message from said second terminal; and
transmitting said altered parameters to said second terminal.

20. The terminal of claim 16, further comprising:
an input/output device between said transmitter/receiver and said processor.
